(19) United States
(12) Patent Application Publication
(10) Pub. No.: US 2011/0209855 A1
(43) Pub. Date: Sep. 1, 2011

(54) COOLING SYSTEM FOR COMPUTER COMPONENTS

(76) Inventors: Eric Peterson, Mckinney, TX (US); Robert Boyd Curtis, Richardson, TX (US)

(21) Appl. No.: 13/126,439

(22) PCT Filed: Oct. 31, 2008
(86) PCT No.: PCT/US2008/081972

§ 371 Date: Apr. 27, 2011

(51) Int. Cl. F28D 15/04; B23P 19/00

(52) U.S. Cl. 165/104.26; 29/426.2

(57) ABSTRACT

A component cooling system comprising a heat spreader 104 configured to contact the top surfaces of components mounted on a component board 102. A heat pipe 106 is attached to the top side of the heat spreader 104. A pair of cooling manifolds 200, where each cooling manifold 200 comprises a body 206 having a channel 320 formed in the body 206 and running from a first end of the body 206 to a second end of the body 206. A fluid inlet 202 attached to the body 206 and coupled to the channel 320. A fluid outlet 204 attached to the second end of the body 206 and coupled to the channel 320. At least one heat pipe clamp 210 movable between an open position and a closed position, the heat pipe clamp 210 configured to hold one end of a heat pipe 106 to the top side of the body 206 when in the closed position.

### BACKGROUND

Computer data centers or computer servers generate large amounts of heat. Most data centers or servers currently use air to cool the computers or the components in the computer systems. Because of the increasing density of the components in the computer systems, the heat density of the computer systems and data centers is increasing.

The increase in heat density requires either higher air flow rates, cooler air, or both to adequately cool the system components. Cooling air to a temperature below the ambient temperature requires a refrigeration system. Refrigeration systems typically use large amounts of power. In fact, the refrigeration systems for a data center may use more than 50% of the total power required by the data center.

Some data centers use liquids as the heat transfer medium instead of, or in addition to, air. Liquids typically have a much higher heat carrying capacity that air. Unfortunately using liquids as the heat transfer medium can make it difficult to modify or replace components in the computer systems because the coolant lines may need to be opened and then re-sealed.

### BRIEF DESCRIPTION OF THE DRAWINGS

FIG. 1A is an exploded isometric view of a component assembly 100 in an example embodiment of the invention.

FIG. 1B is an isometric view of a component assembly 100 in an example embodiment of the invention.

FIG. 1C is an isometric view of a heat spreader in another example embodiment of the invention.

FIG. 2 is an isometric view of a cooling manifold 200 in an example embodiment of the invention.

FIG. 3A is an isometric cutaway view of a cooling manifold 300 in an example embodiment of the invention.

FIG. 3B is a cutaway side view of cooling manifold 300 in an example embodiment of the invention.

FIG. 3C is an isometric cutaway view of a cooling manifold 301 in another example embodiment of the invention.

FIG. 3D is a cutaway side view of cooling manifold 301 in an example embodiment of the invention.

FIG. 4 is an isometric view of a computer board assembly 400 in an example embodiment of the invention.

FIG. 5 is another isometric view of computer board assembly 400 in an example embodiment of the invention.

### DETAILED DESCRIPTION

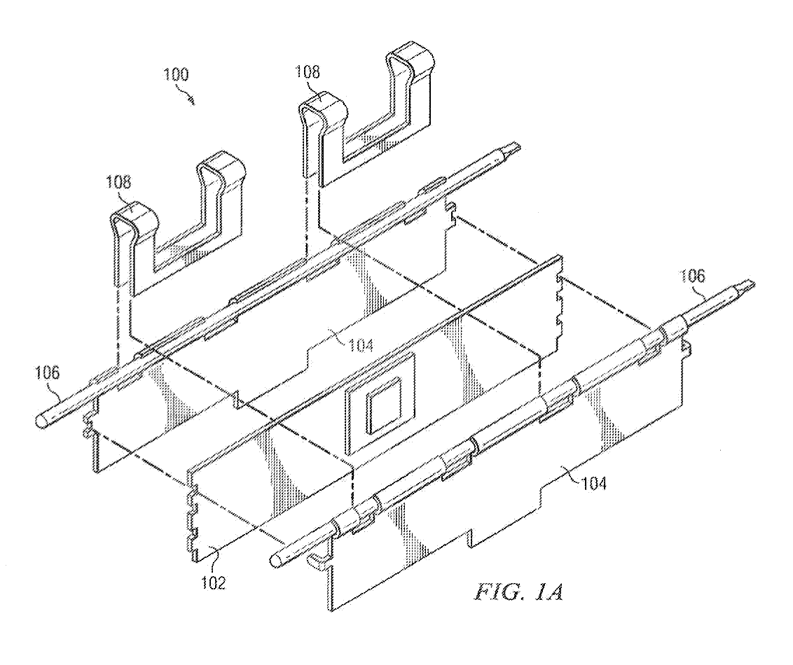

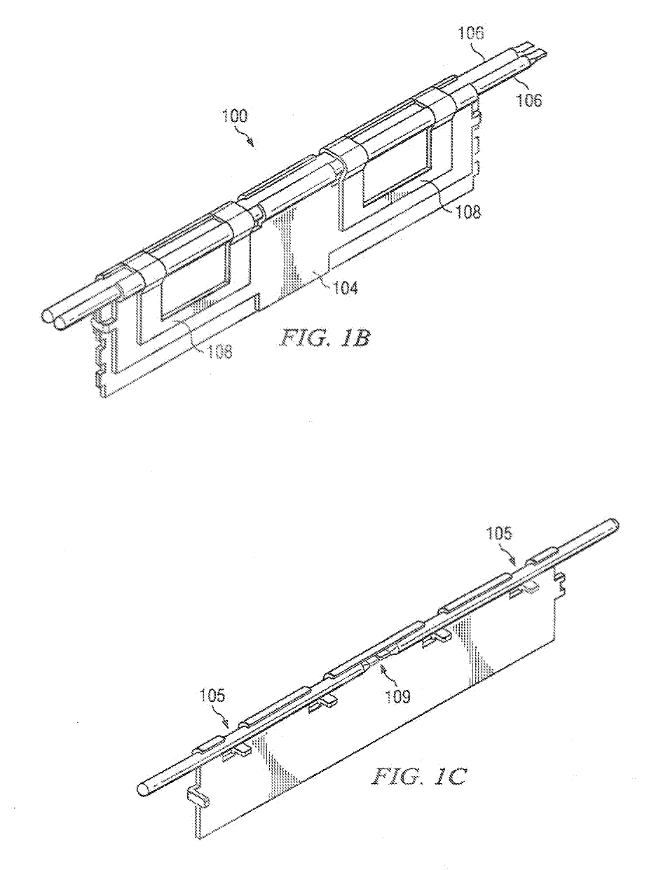

FIGS. 1-5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1A is an exploded isometric view of a component assembly 100 in an example embodiment of the invention. Component assembly 100 comprises a component board 102, two heat spreaders 104, two heat pipes 106, and two clips 108. Component board 102 may comprise a dual in-line memory module (DIMM), an application specific integrated circuit (ASIC) mounted to a PC board, or any other type of electronic component mounted to a PC board that requires cooling. Heat spreaders 104 may be a plate formed to contact the top surfaces of the components mounted onto component board 100. The two heat spreaders 104 may be mirror images of each other or may have different shapes to match differently shaped components mounted on the two sides of component board 102.

FIG. 1B is an isometric view of a component assembly 100 in an example embodiment of the invention. In operation, the two heat spreaders 104 are held against the components mounted on the front and/or back face of component board 100 by clips 108. Clips are shown in this example embodiment, but any suitable method may be used to hold heat spreaders in place. A thermal interface material such as grease may be used to increase the thermal coupling between the components mounted onto the component board 100 and the heat spreaders 104. In another example embodiment of the invention, a vapor chamber can be added to the heat spreader to increase the thermal efficiency. The vapor chamber may be located between the heat spreader and the thermal interface material, or may be in direct contact with the components mounted on the component board. A heat pipe 106 is coupled to the top side of each of the heat spreaders 104. In one example embodiment of the invention, the heat pipes 106 slide into a cylindrical opening formed along the top of each heat spreader 104. The heat spreaders 104 transfer heat from components, mounted on component board 100, to heat pipes 106.

In another embodiment of the invention, only one heat spreader may be used in each component assembly. The single heat spreader may be used in component assemblies where components are mounted to only one side of PC board 102, or in cases where the components generate less heat. The single heat spreader may be attached to component board 102 using clips 108. A single heat pipe 106 would be coupled to the top side of heat spreader 104.

The ends of a heat pipe have a certain amount of dead space due to the construction of the heat pipe. The dead space is typically larger at the fill end of the heat pipe. Two heat pipes can he used in place of one heat pipe, where the two fill ends are located next to each other in the center of the heat spreader. FIG. 1C is an isometric view of a heat spreader in another example embodiment of the invention. Heat spreader 104 has two heat pipes 105 mounted into the top side of heat spreader 104. The two heat pipes 105 are mounted end-to-end such that the two fill ends are located in the center 109 of heat spreader 104. This provides a heat pipe assembly with two non-fill ends that mate with the cooling manifold. This may help to minimize the dead space in the heat pipes that couple to the cooling manifolds.

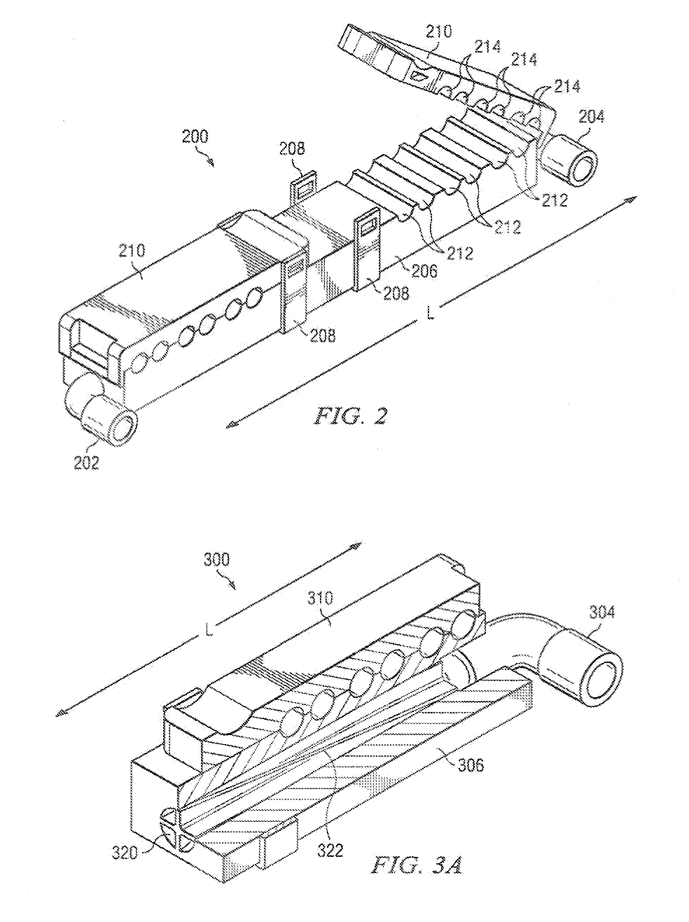

FIG. 2 is an isometric view of a cooling manifold 200 in an example embodiment of the invention. Cooling manifold 200 comprises body 206, cooling fluid inlet port 202, cooling fluid exit port 204, four locking clips 208 and two heat pipe clamps 210. Cooling fluid inlet port 202 is mounted at one end of body 206. Cooling fluid exit port 204 is mounted at the other end of body 206.

A heat pipe clamp 210 is attached to each end of body 206 on the top side of body 206. The heat pipe clamps 210 are attached to body 206 such that they can rotate between an open position and a closed position. The heat pipe clamp 210 on the right side of FIG. 2 is shown in a partially opened position. The heat pipe clamp 210 on the left side of FIG. 2 is shown in a closed position.

There is a tab formed on each side of one end of the heat pipe clamps 210. Two locking clips 208, mounted to body 206, snap over the two tabs to hold each heat pipe clamp 210 into the closed position. Other locking mechanisms may be used to hold the heat pipe clamps into the locked or closed position, for example: a single clip, a screw, a latch, a snap, or the like. In other example embodiments of the invention, each heat pipe clamp may have locking mechanisms at both ends and snap into the closed position using a linear motion instead of a rotational motion.

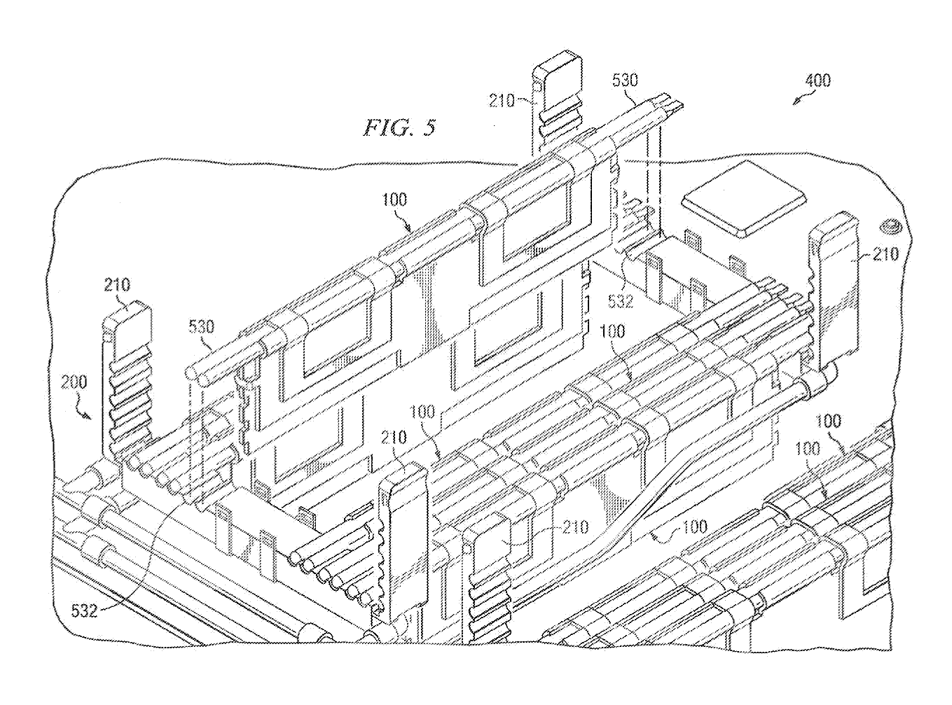

A plurality of cylindrical openings are formed between the top surface of body 106 and the bottom surface of heat pipe clamps 210, with part of the cylindrical openings 212 formed in the top surface of body 206 and part of the cylindrical openings 214 formed in the bottom surface of heat pipe clamp 210. The plurality of cylindrical openings are perpendicular to the long axis L of body 206. The plurality of cylindrical openings are configured to mate with the ends of the heat pipes (see FIG. 5) in component assembly 100. A thermal interface material such as thermal grease or a thermal gap pad may be used between the heat pipe ends 106 and the body/heat pipe clamp 206/210 to increase the thermal coupling. In another example embodiment of the invention, only one heat pipe clamp may be used to hold all the heat pipes onto the cooling manifold 200.

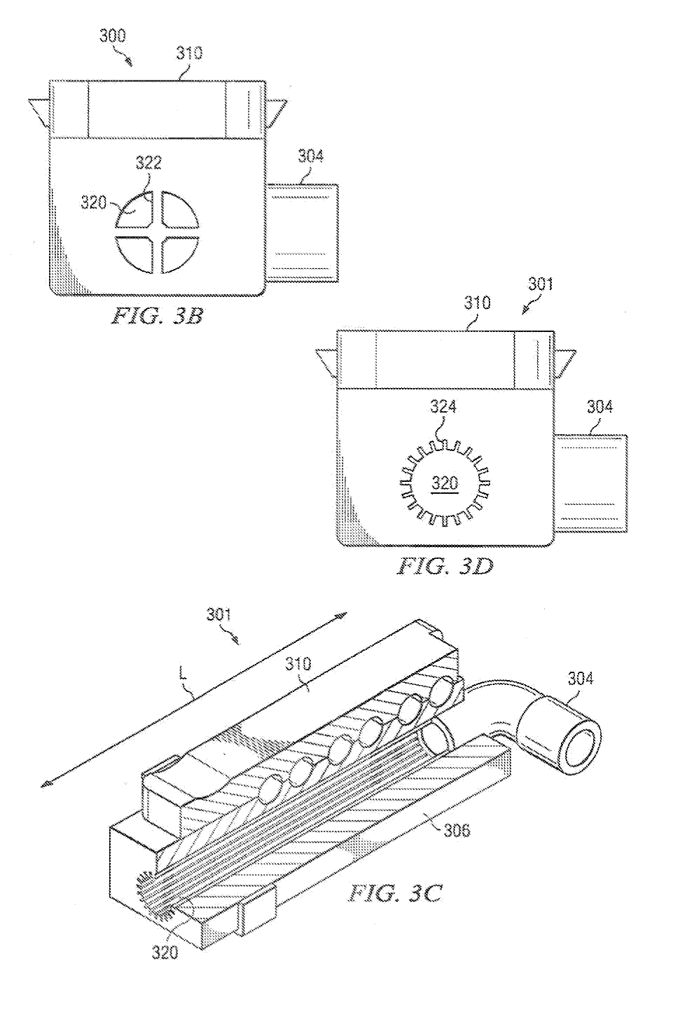

FIG. 3A is an isometric cutaway view of a cooling manifold 300 in an example embodiment of the invention. Cooling manifold 300 comprises body 306, heat pipe clamp 304, and cooling fluid exit port 304. Cooling manifold 300 has heat pipe clamp 310 shown in the closed position. An opening or channel 320 runs from cooling fluid inlet port (not shown), through body, and exits through cooling fluid exit port 304. In operation, fluid flows from cooling fluid inlet port 302, through channel 320, and then exits through cooling fluid exit port 204. The fluid removes heat from body 306. Fins 322 may be formed into the inside of channel 320 to increase the heat exchange rate between the fluid flowing through channel 320 and body 306.

Fins 322 may be added to channel 320 by either extruding a fin structure into body 306 during fabrication or creating a fin component and press fitting the component into body 306. Fins 322 could be twisted along the length of channel 320 to help distribute the liquid along the length of channel 320 and increase the heat transfer between the liquid and the body 306. The twisted fins may also increase the heat transfer by increasing the laminar flow of the liquid through the channel 320.

FIG. 3B is a cutaway side view of cooling manifold 300 in an example embodiment of the invention. Cooling manifold 300 comprises body 306, heat pipe clamp 304, and cooling fluid exit port 304. Opening or channel 320 is formed running through the long axis of body 306. Opening or channel 320 may have fins 322 formed into channel 320.

FIG. 3C is an isometric cutaway view of a cooling manifold 301 in another example embodiment of the invention. Cooling manifold 301 comprises body 306, heat pipe clamp 304, and cooling fluid exit port 304. Cooling manifold 301 has heat pipe clamp 310 shown in the closed position. An opening or channel 320 runs from cooling fluid inlet port (not shown), through body 206, and exits through cooling fluid exit port 304. In operation, fluid flows from cooling fluid inlet port 302, through channel 320, and then exits through cooling fluid exit port 204. The fluid removes heat from body 306. Ridges 324 may be formed into the inside of channel 320 to increase the area wetted by fluid flowing through channel 320, thereby increasing the heat transfer rate.

FIG. 3D is a cutaway side view of cooling manifold 301 in an example embodiment of the invention. Cooling manifold 301 comprises body 306, heat pipe clamp 304, and cooling fluid exit port 304. Opening or channel 320 is formed running through the long axis of body 306. Opening or channel 320 may have ridges 324 formed into channel 320.

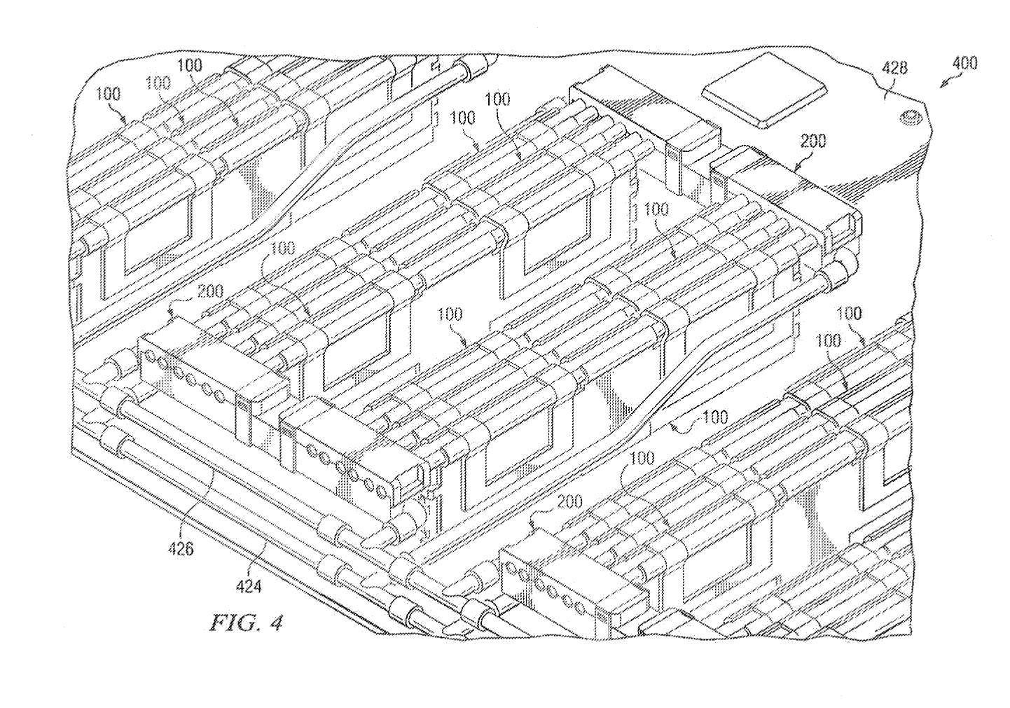

FIG. 4 is an isometric view of a computer board assembly 400 in an example embodiment of the invention. Computer board assembly 400 comprises a cooling fluid supply line 424, a cooling fluid return line 426, a printed circuit (PC) board assembly 428, a plurality of cooling manifolds 200 and a plurality of component assemblies 100. In one example embodiment of the invention, the plurality of cooling manifolds 200 are mounted onto PC board assembly 428 in pairs with component assemblies 100 held in place between each pair of cooling manifolds 200. The plurality of component assemblies 100 are also electrically coupled to PC board assembly 428. The cooling fluid supply line 424 is coupled to one end of each of the cooling manifolds 200. The cooling fluid return line 426 is coupled to the other end of each of the cooling manifolds 200.

In operation, cooling fluid flows from cooling fluid supply line 424, into one end of each of the plurality of cooling manifolds, through the body of cooling fluid manifold, out through the other end of each of the cooling manifolds, and into the cooling fluid return line 426. Heat from the components mounted onto the PC board 102, transfers into heat spreaders 104, and then into heat pipes 106. The heat then flows from the heat pipes 106 into cooling manifolds 200. The fluid flowing through cooling manifolds 200 removes the heat from the cooling manifolds 200. The heat is then transferred out of the system through the cooling fluid return lines. The cooling fluid supply lines and the cooling fluid return lines may be coupled to a heat exchanger, a refrigerator, a chiller, or the like.

In one example embodiment of the invention, the fluid flow could be configured to run in opposite directions in the two cooling manifolds mounted on each end of a set of component assemblies 100. This would allow for a more uniform temperature to be maintained between each component assembly mounted between the two cooling manifolds 200.

FIG. 5 is another isometric view of computer board assembly 400 in an example embodiment of the invention. In this view, each of the heat pipe clamps 210 are shown in the open position. Component assembly 101 is shown as it is being inserted into cooling manifolds 200. All the other component assemblies 100 are shown already mounted into cooling manifolds 200. As component assembly 101 is lowered into cooling manifolds 200, the two ends 530 of each of the two heat pipes 106, fit into the cylindrical openings 532 formed in the cooling manifolds 200. The lower edge of component assembly 101 couples to, and makes electrical contact with, PC board assembly 428. Once component assembly 101 is in place, heat pipe clamps 210 can be moved into the closed and locked position, thereby holding all the component assemblies in place.

Because heat pipe clamps 210 move between an open and a closed position, component assemblies 100 can be added or removed while the fluid cooling system remains sealed. This allows a close coupling between the fluid cooling system and the components to be cooled. The fluid cooling system also remains sealed when the computer board assembly 400 is not fully loaded with some component assemblies 100 not present in the computer board assembly 400. In one example embodiment of the invention a failed component can be replaced or an additional component can be added without opening the sealed fluid cooling units. When a failed component is detected, if the component is not hot swappable, the computer board assembly 400 is powered down. The heat pipe clamps holding the failed component are moved from the closed position into the open position. The component assembly containing the failed component is removed from the computer board assembly 400. A replacement component assembly 100 is inserted into the open location. The heat pipe clamps are then moved back into the closed position. During this process, the fluid cooling system remains sealed and may remain operational.

What is claimed is:

1. A component cooling apparatus, comprising:
a first heat spreader 104 comprising a plate having a top side and a front face where the plate is shaped such that the front face is contoured to contact a top side of at least one component mounted on a component PC board 102;
a heat pipe 106 coupled to the first heat spreader 104 along the top side of the first heat spreader 104, the heat pipe 106 having two ends;
two cooling manifolds 200, where each of the cooling manifolds 200 comprises:
a body 206 with a first end and a second end;
a channel 320 formed into the body 206 and running between the first end of the body 206 and the second end of the body 206;
a fluid inlet 202 attached to the first end of the body 206 and coupled to the channel 320;
a fluid outlet 204 attached to the second end of the body 206 and coupled to the channel 320;
at least one heat pipe clamp 210 configured to move between an open position and a closed position, the heat pipe clamp 210 configured to capture and hold one of the two ends of the heat pipe 106 against a top side of the body 206 when in the closed position.

2. The apparatus of claim 1, further comprising:
a PC board assembly 428 having a top side, wherein the two cooling manifolds 200 are mounted on the top side of the PC board assembly 428 in a spaced apart configuration;
the component PC board 102 with the at least one component contacting the front face of the first heat spreader 104, where the component PC board 102 is electrically coupled to the top side of the PC board assembly 428 between the two cooling manifolds 200.

3. The apparatus of claim 2, wherein at least one clip 108 is used to mount the first heat spreader 104 against the at least one component.

4. The apparatus of claim 2, further comprising:
a second heat spreader 104 mounted against the component PC board 102 on the opposite side from the first heat spreader 104, the second heat spreader 104 having a top side;
a heat pipe 106 coupled to the second heat spreader 104 along the top side of the second heat spreader 104, the heat pipe 106 having two ends.

5. The apparatus of claim 2, wherein a thermal interface material is placed between the front face of the first heat spreader 104 and the top side of the at least one component.

6. The apparatus of claim 1, further comprising:
a chilling unit having a cooling fluid supply line 424 and cooling fluid return line 426, wherein the chilling unit supplies chilled cooling fluid into the cooling fluid supply line 424 and retrieves the cooling fluid from the cooling fluid return line 426, and where the cooling fluid supply line 424 is coupled to the fluid inlet 202 of each of the two cooling manifolds 200 and the cooling fluid return line 426 is coupled to the fluid outlet 204 of each of the two cooling manifolds 200.

7. The apparatus of claim 1, wherein the fluid inlet 202 of a first of the two cooling manifolds 200 is attached to the first end of its body 206 and the fluid inlet 202 of the second of the two cooling manifolds 200 is attached to the second end of its body 206, whereby the fluid flows in opposite directions through the two cooling manifolds 200.

8. The apparatus of claim 1, wherein a plurality of cylindrical openings 212 are formed between the top surface of the body 206 and a bottom surface of the at least one heat pipe clamp 210, perpendicular to a long axis of body, and where each of the plurality of cylindrical openings 212 are formed to mate with one of the two ends of the heat pipe 106.

9. The apparatus of claim 1, wherein the heat pipe clamp 210 move between the open position and the closed position using a rotational motion.

10. The apparatus of claim 1, wherein the heat pipe clamp 210 move between the open position and the closed position using a linear motion

11. The apparatus of claim 1, wherein the inside of the channel 320 has a shape selected from the group comprising: fins 322 and ridges 324.

12. The apparatus of claim 11, wherein the shape selected from the group comprising: fins and ridges, rotates along a length of the channel.

13. The apparatus of claim 1, wherein the heat pipe clamp 210 is locked into the closed position using a locking clip 208 that snaps over at least one tab formed on the heat pipe clamp 210.

14. A method for replacing a failed components in a computer system, comprising:
determining the location of a pair of cooling manifolds holding a failed component, the pair of cooling manifolds each having at least one heat pipe clamp;
moving the at least one heat pipe clamp on each cooling manifold from a closed position into an open position while a fluid cooling unit attached to the pair of cooling manifolds remains sealed;
removing a component assembly containing the failed component from between the pair of cooling manifolds;
inserting a replacement component assembly between the pair of cooling manifolds;
moving the at least one heat pipe clamp on each cooling manifold from the open position into the closed position.

15. The method of claim 14, wherein the failed component is hot swappable and a PC board assembly containing the failed component remains powered up as the replacement component is inserted.
